(19) United States
(12) Patent Application Publication
(10) Pub. No.: US 2013/0236254 A1
(43) Pub. Date: Sep. 12, 2013

(54) TWO-MATERIAL ONE-PIECE CUTTING TOOL

(71) Applicant: Eric Englebert, Villers-Le-Bouillet (BE)

(72) Inventor: Eric Englebert, Villers-Le-Bouillet (BE)

(73) Assignee: TECHSPACE AERO S.A., Herstal (Milmort) (BE)

(21) Appl. No.: 13/885,712

(22) PCT Filed: Oct. 27, 2011
(86) PCT No.: PCT/EP2011/068896

§ 371 Date: May 16, 2013

(30) Foreign Application Priority Data
Nov. 29, 2010 (EP) 10193014.7

(51) Int. Cl. B23C 5/00

(52) U.S. Cl. CPC B23C 5/003
USPC 407/32

(57) ABSTRACT

The invention relates to a cutting tool, more particularly to a monobloc carbide cutter comprising a rod shrunk within the body of the cutter and extending to the so-called front end of the cutter having cutting edges. The shrunken rod enables bending vibrations to be damped through friction. Each cutting edge is formed directly and continuously from the material of the rod and the material of the body. As those parts of the cutting edges formed in the material of the rod rotate at lower speeds than those parts formed in the material of the body, the material of the rod can have cutting speed performance lower than that of the material of the body.

### CROSS-REFERENCE TO RELATED APPLICATIONS

The present invention is the US national stage under 35 U.S.C. §371 of International Application No. PCT/EP2011/068896, which was filed on Oct. 27, 2011 and which claims the priority of application EP 10193014.7 filed on Nov. 29, 2010 the content of which (text, drawings and claims) is incorporated here by reference in its entirety.

### FIELD

The invention relates to a cutting tool, especially a monobloc cutting tool, particularly a milling cutter.

### BACKGROUND

Cutting tools, especially slot milling cutters or end mills are commonly of monobloc construction, and made of high speed steel (HSS) or carbide. Using carbide, especially tungsten carbide, enables substantially higher machining speeds to be achieved than can be obtained using high speed steel. High-speed machining as well as high feed speeds can cause vibrations, in particular by bending of the milling cutter. In many applications the onset of vibrations is the predominant factor limiting productivity and requires operators to reduce cutting speeds well below the capacity of the cutting tools or the machine. The length of the cutting tool plays an important role in bending and bending vibrations. These vibrations can have a significant effect on the surface finish. This is particularly true when machining complex 3D parts.

Patent DE 42 14 355 A1 addresses the problem of bending and the associated vibrations in milling tools. It discloses a carbide-tipped cutting tool comprising an internal rod insert in the tool extending from the shank of the tool up to the tool's carbide tip. The insert is an interference fit in a blind hole made in the body of the tool. It is drilled along its length so as to provide a supply of cutting fluid near the carbide tip. This arrangement ensures a frictional connection between the insert and the body of the tool. The insert is made of a harder material than the body so as to increase tool rigidity and dampen vibrations. The implementation of this interpretation involves a significant manufacturing overhead.

### SUMMARY

The present invention provides a powerful monobloc cutting tool, particularly a rigid cutting tool that is not prone to bending vibrations.

The invention provides a rotary cutting tool comprising: a body having a longitudinal axis; at least one cutting edge located on the so-called front end of the body; and a core mounted in the body with an interference fit and extending over at least a portion of the body so as to at least partially absorb any bending vibration of the tool during use; wherein the core extends to the front end of the body and the cutting edge is at least partially formed in the material of the core.

The core is preferably a solid bar. The core can also be drilled longitudinally. The core is preferably made of a single piece. However, the core can also consist of several sections.

The cutting tool is preferably a milling cutter.

Preferably, the tolerances in the diameter of the core and the corresponding bore of the body are such that the diameter of the core is strictly greater than the diameter of the bore before fitting.

According to an advantageous embodiment of the invention, the cutting edge is partially formed in the material of the body.

According to another advantageous embodiment of the invention, the profile of the cutting edge is continuous at the junction between the core and the body.

According to yet another advantageous embodiment of the invention, the material of the core is different from that of the body.

According to a further advantageous embodiment of the invention, the material of the core has a cutting speed for a given material that is preferably 20% less, more preferably 30%, 40%, 50%, 60% or 70% less, than the material of the body.

According to a further advantageous embodiment of the invention, the core material is HSS and the body is carbide cutting material, preferably tungsten carbide.

According to a further advantageous embodiment of the invention, the surface of the core at the front end of the body is continuous with the adjacent surface of the body.

According to yet another advantageous embodiment of the invention, the material of the core is cylindrical and concentric with the body.

According to a further advantageous embodiment of the invention, the diameter of the core is greater than or equal to 15%, preferably 20%, 25%, 30%, 35%, 40%, 45% or 50% of the mean diameter of the body.

According to yet another advantageous embodiment of the invention, the core is conical and concentric with the body.

According to a further advantageous embodiment of the invention, the body comprises at least one helical flute extending along the body from the cutting edge, the core extending longitudinally for at least the length of the tool's flute.

According to a further advantageous embodiment of the invention, the core extends longitudinally for at least 30%, preferably 50%, 60%, 70%, 80%, 90% or 100% of the length of the body.

According to a further advantageous embodiment of the invention, the body comprises an attachment shank and the core extends longitudinally so as to stop at the end of the said shank.

According to a further advantageous embodiment of the invention, the tool comprises at least two symmetrical cutting edges at the front end of the body.

According to a further advantageous embodiment of the invention, the tool comprises at least one cutting edge on the lateral surface of the body.

The characteristics mentioned above correspond to various embodiments of the invention and can be considered separately or in combination.

### DRAWINGS

FIG. 1 is a plan view of a first cutting tool according to the invention.

FIG. 2 is an enlarged elevation view of the first cutting tool shown in FIG. 1, in accordance with the invention.

FIG. 3 is a plan view of a second cutting tool in accordance with the invention.

FIG. 4 is an enlarged elevation view of the second cutting tool shown in FIG. 3, in accordance with the invention.

### DETAILED DESCRIPTION

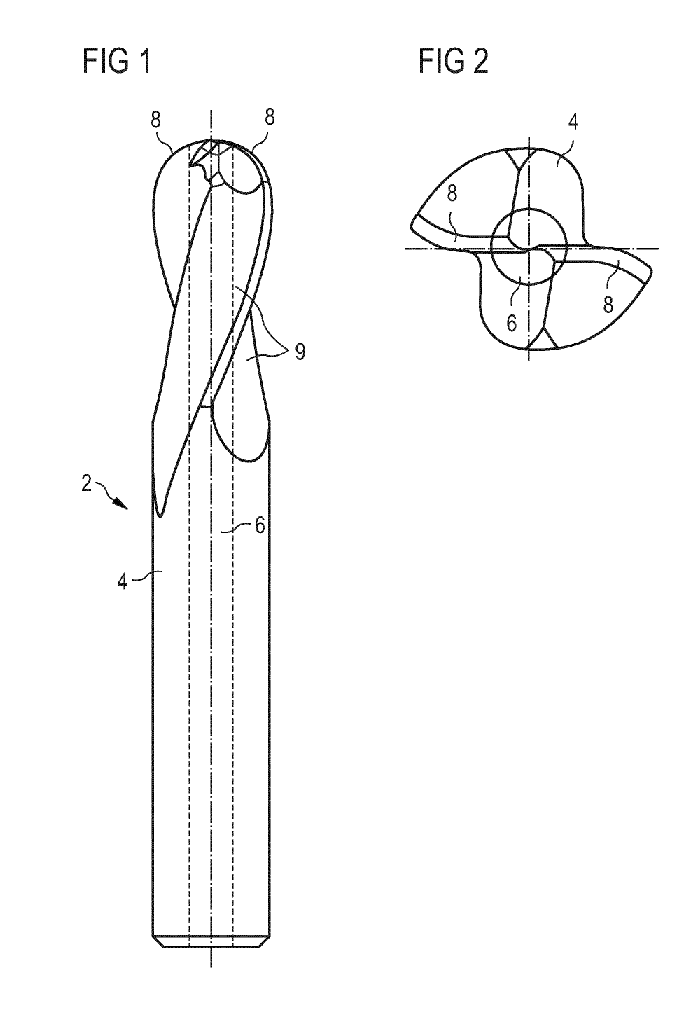

FIGS. 1 and 2 are illustrations of a monobloc HSS/carbide cutting tool with a cylindrical shank, ball nose and with two teeth. The cutting tool, having a rounded shape, enables complex three-dimensional surfaces to be machined.

The cutting tool 2 comprises a tungsten carbide body 4 in which a high speed steel (HSS) cylindrical rod 6 is inserted. The rod 6 extends the full length of the tool 2 and is arranged concentrically to the body 4, the body 4 being generally cylindrical. The upper part or head of the tool has two cutting edges or teeth 8 at the tip of the head. The two cutting edges 8 each have quarter circular profiles, the two cutting edges 8 being diametrically opposed so that together their profiles form a hemispherical profile.

The HSS rod or core 6 forms the central portions of the two cutting edges 8 whereas the body 4 forms the side portions of the two cutting edges 8. The cutting edges 8 are thus formed of two different materials.

The cutting tool 2 also has two helical flutes 9 for chip removal, each extending from a cutting edge 8.

The HSS rod core 6 is shrunk into the body 4, specifically as an interference fit. During the manufacture of the cutting tool 2, especially when making the body 4 and the core 6, a person skilled in the art selects the dimensions and manufacturing tolerances, particularly those associated with the respective diameters, which will ensure sufficient clamping between the two elements, i.e., between the body 4 and the HSS rod 6, so as to ensure a frictional connection. These dimensions and tolerances depend on the materials involved and the size of the tool 2.

The carbide body 4 is typically made by sintering. The composition of the body 4 is variable, depending on the characteristics of this material. The body 4 comprises 80% to 95% tungsten with cobalt supplements and a variety of alloying elements such as niobium. The body bore is thus formed at the start of manufacture of the body 4. The core 6 is manufactured conventionally in HSS. The cord 6 is then shrunk into the body 4. The cutting edges 8 are then formed in a conventional manner from the roughed body shape and the core 6.

The cutting tool 2 shown in FIGS. 1 and 2 has two major advantages, namely:

(i) Having the rod 6 set into the hollow body 4 of the tool 2 creates a contact surface through which energy can be dissipated by friction, depending on the bending experienced by the tool 2 when working. The energy dissipation dampens the vibrations caused by the interrupted cutting involved in milling. The main sources of vibration are twofold: forced vibration and self-sustaining vibrations. Forced vibrations are caused mainly by eccentric spindle/tool/tooth alignment, interruptions during cutting (inevitable in milling, for example), as well as from sources external to the machine. Self-sustaining vibrations are related to the fact that the thickness of a chip depends on the position of the cutting edge 8 relative to the workpiece, but also to the position of the previous pass. Thus, vibrations may appear that are amplified by each pass of the tool until the vibrations stabilize at a level that may spoil the quality of the machined surface.

(ii) The highest performance cutting material works at the highest speed (cutting speed being proportional to the distance between the cutting edge 8 and the tool's 2 axis of rotation) and the lowest performance cutting material works at a lower speed.

The ratio of the radii is mainly based on the recommended cutting speeds for both materials in the material to be machined.

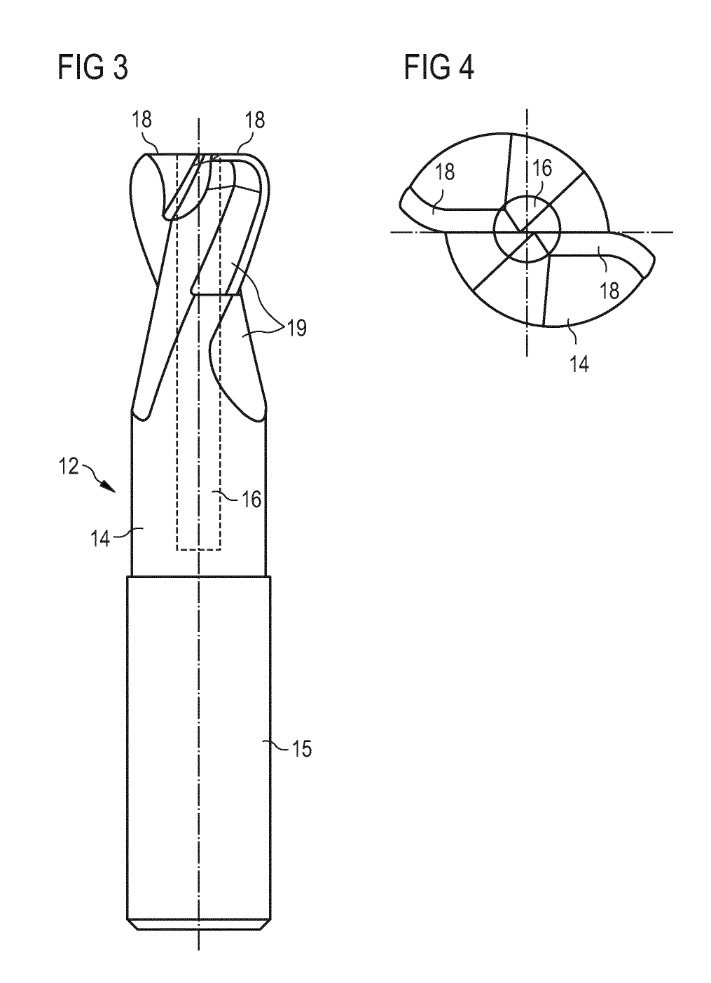

FIGS. 3 and 4 illustrate a second embodiment of the cutting tool invention, specifically a monobloc HSS/carbide cutter with a cylindrical shank and two teeth. The cutting tool or cutter 12 comprises a body 14 made of tungsten carbide, a first portion with a cylindrical shank 15 and a second portion corresponding to the tool tip. The cutting tool 12 has two teeth or cutting edges 18 at an end or front face of the tool 12. A core 16 in the form of a solid cylinder is located concentrically in the tool head, extending from the end or front face to the vicinity of the shank 15 of the tool. The cutter 12 is provided with two helical flutes 19 for chip removal. The core 16 extends from the end or front face to just beyond the flutes 19.

Although the core 16 does not extend the entire length of the cutter 12, the core 16 has, however, the same benefits as the cutter 2 illustrated in FIGS. 1 and 2, namely

(i) The dissipation of energy by friction between the core 16 and the corresponding bore in the body 14. Depending on various parameters, such as the diameter of the shank 15, the length of the tool 12, a working speed of the tool 12 and the resultant cutting loads, it may be sufficient to limit the length of the core 16 to the tool tip without sacrificing any vibration damping.

(ii) Optimal use of cutting materials, with the less performing material at the center of rotation (or near the center) and the better performing material at some distance from the center of rotation.

Similar to the cutting tool 2 shown in FIGS. 1 and 2, the rod 16 forming the core 16 is shrunk into a corresponding bore of the body 14.

Both cutting tool models 2 and 12 shown in FIGS. 1-4 are given merely as examples. The invention is applicable to other models of milling cutters and types of cutting tool such as end mills or drills.

It should be noted that the core 6/16 does not necessarily need to be cylindrical. In fact, the core 6/16 can have some taper. In this case, the corresponding bore in the body 4/14 has a corresponding taper.

It should be noted that the core 6/16 does not necessarily need to be made of HSS. The core 6/16 can be made of a carbide material but one of lower performance. Similarly, the body 4/14 does not need to be made of carbide. The body 4/14 can be made of HSS with superior performance to the HSS of the core 6/16. The principle is to select a material for the core 6/16 which is of lesser performance and less expensive while maintaining the overall performance of the tool 2/12.

1.-15. (canceled)

16. A rotating cutting tool comprising:
a body with a longitudinal axis;
at least one cutting edge located on a front end of the body;
a core joined to the body with an interference fit and extending over at least a portion of the body so as to at least partially absorb the bending vibrations of the tool during its use;
wherein the core extends to the front end of the body and the cutting edge is at least partially formed of the core material.

17. The cutting tool in accordance with claim 16, wherein the cutting edge is partially formed of the material of the body.

18. The cutting tool in accordance with claim 17, wherein a profile of the cutting edge is continuous at a junction between the core and the body.

19. The cutting tool in accordance with claim 16, wherein the material of the core is different from the material of the body.

20. The cutting tool in accordance with claim 19 wherein the material of the core has a cutting speed for a given material to be machined which is less than that of the material of the body.

21. The cutting tool in accordance with claim 20 wherein the material of the core has a cutting speed for a given material to be machined which is 50% less than that of the material of the body.

22. The cutting tool in accordance with claim 16, wherein the core is made of high speed steel and the body is made of a carbide cutting material.

23. The cutting tool in accordance with claim 16, wherein a surface of the core at the front end of the body is continuous with an adjacent surface of the body.

24. The cutting tool in accordance with claim 16, wherein the core is cylindrical and concentric with the body.

25. The cutting tool in accordance with claim 24, wherein a diameter of the core is greater than or equal to one of 15%, 20%, and 30% of a mean diameter of the body.

26. The cutting tool in accordance with claim 16, wherein the core is conical and concentric with the body.

27. The cutting tool in accordance with claim 16, wherein the body comprises at least one helical flute extending along the body from the cutting edge, the core extending longitudinally for at least the length of the at least one flute.

28. The cutting tool in accordance with claim 16, wherein the core extends longitudinally over one of at least 30%, 50%, and 100% of the length of the body.

29. The cutting tool in accordance with claim 16, wherein the body comprises a shank and the core extends longitudinally so as to stop at the end of the shank.

30. The cutting tool in accordance with claim 16 further comprising at least two symmetrical cutting edges at the front end of the body.

31. The cutting tool in accordance with claim 16 further comprising at least one cutting edge on a lateral surface of the body.
